(19) United States
(12) Patent Application Publication
(10) Pub. No.: US 2005/0076092 A1
(43) Pub. Date: Apr. 7, 2005

(54) User shared virtual channel via media storage

(75) Inventors: Matthew Chang, San Diego, CA (US); Frederick J. Zustak, Poway, CA (US); Andrew M. Proehl, San Francisco, CA (US); Nicholas Colsey, Del Mar, CA (US); Peter R. Shintani, San Diego, CA (US); Mark K. Eyer, Woodinville, WA (US)

Correspondence Address: O'BANION & RITCHEY LLP/ SONY ELECTRONICS, INC., 400 CAPITOL MALL, SUITE 1550, SACRAMENTO, CA, 95814, US

(73) Assignee: SONY CORPORATION AND SONY ELECTRONICS INC.

(21) Appl. No.: 10/810,248

(22) Filed: Mar. 26, 2004

Related U.S. Application Data
(60) Provisional application No. 60/508,793, filed on Oct. 2, 2003.

(51) Int. Cl. G06F 15/16

(52) U.S. Cl. 709/217

(57) ABSTRACT

A system for sharing media content between peers over a communication medium. Content is authenticated prior to being downloaded, or stored, so that only content from designated peers, or based on other user selected criteria, reaches the user. Typically, content is stored at the destination site on a fixed or removable media prior to user content playback. Users are notified of content receipt, such as by an entry within a programming guide through which convenient user access of content may occur without the need to log onto the Internet or other service. The media content is then played back over a virtual channel that is selected by the user. The functionality of the system may be embodied within a separate unit or incorporated within set-top boxes, television sets, audio systems, gaming systems, personal computer system, or other interconnected electronic devices. Content may be communicated between peers on a device back-channel over a telephone system, Internet, cable network, powerline network, wireless connection, or direct wired link.

### CROSS-REFERENCE TO RELATED APPLICATIONS

This application claims priority from U.S. Provisional Application Ser. No. 60/508,793 filed on Oct. 2, 2003, incorporated herein by reference.

### STATEMENT REGARDING FEDERALLY SPONSORED RESEARCH OR DEVELOPMENT

Not Applicable.

### INCORPORATION-BY-REFERENCE OF MATERIAL SUBMITTED ON A COMPACT DISC

Not Applicable.

### NOTICE OF MATERIAL SUBJECT TO COPYRIGHT PROTECTION

A portion of the material in this patent document is subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F.R. § 1.14.

### BACKGROUND OF THE INVENTION

1. Field of the Invention

This invention generally pertains to content distribution, and more particularly to systems and methods of sharing of audio and/or video content over a remote communication medium and providing access to that content over a virtual channel.

2. Description of Related Art

Consumers are being inundated with content from media and advertising channels over television, radio, and the Internet. Home lives often seem to center around the television set with average viewing times per individual exceeding many hours per day. However, individuals find it increasingly difficult amidst their busy schedules to maintain contact with family and friends.

The current availability of cameras, video recorders, and the like provide an affordable mechanism for registering and recording content for events in our lives, yet this content is not readily shared with our friends and family. Although audio and/or video content, after being properly formatted may be attached to an email, or put up on a web site, for sharing with other parties, the process is complicated and involves a number of steps. Individuals that do not regularly log onto their personal computer systems, or that are not computer savvy, often struggle with attempting to communicate in this manner. Additionally, persons receiving email are subject to battling with unwanted solicitations, or “SPAM”, making it difficult to wade through all the unsolicited garbage to find content from actual friends and family. Current trends in the convergence of the personal computer and video recorder and/or television have not simplified peer-to-peer content sharing.

Therefore, a need exists for a system and method of sharing audio and/or video content with friends and family that is easy to use, while not being subject to “SPAM” from advertisers and other organizations and individuals that the user does not wish to receive content from. The present invention satisfies those needs, as well as others, and overcomes the deficiencies of previously developed content sharing systems and methods.

### BRIEF SUMMARY OF THE INVENTION

The present invention is a system and method of sharing content (i.e. audio and/or video) in which content may be received from selected parties over a common communication medium and easily played back at the user's discretion over a virtual channel. As used herein, the term “virtual channel” refers to a channel which can be “tuned” to an internal or media storage location for playback of the content as opposed to a broadcast or cable channel.

In general terms, the invention comprises a receiver configured to automatically receive content from at least one preauthorized sender. Once received, the content is locally stored on internal or external media storage and indexed for later retrieval and playback over a virtual channel. A user interface provides a list of channels for playback, which can include one or more broadcast channels, cable channels, and virtual channels. The user tunes to a virtual channel, rather than a broadcast or cable channel, to access the stored content.

By way of example, and not of limitation, each virtual channel is identified by a descriptor for channel selection. The user can then access the virtual channel through an electronic program guide (EPG) by scrolling through a list of channels which can include broadcast channels, cable channels, and virtual channels. Examples of electronic program guides with virtual channels can be found in published U.S. Patent Application No. 2002/0157100 and published U.S. Patent Application No. 2002/0157098, both of which are incorporated herein by reference in their entirety. Alternatively, the user can enter a number or code on a local or remote keypad to select the virtual channel directly. When a virtual channel is selected, the system accesses a storage location for playback instead of accessing a broadcast or cable tuner. Accordingly, the system provides a low overhead approach for peer-to-peer or client/server content sharing, which overcomes the numerous steps and complications that arise when attempting to share content as email attachments or web site content.

By way of further example, in one embodiment of the invention content is distributed to a destination associated with a known party or select group of parties. Prior to storing the content, the destination authorizes the identity of the sending party, either directly or indirectly. Preferably, a notification in the form of one or more electronic program guide (EPG) entries is generated for the destination user. The notification can be preferably selected by the user for accessing the associated content, such as playing a video file on an attached television set.

The present invention overcomes a number of the obstacles that arise in maintaining contact and sharing life's many events with friends and family. The invention may be implemented within a set-top box, or other electronics, such as video recorders, televisions, personal computers, and the like. Content may be communicated utilizing telephone lines, cable networks, powerline networks, Internet, wireless connectivity, wired connections, or combinations thereof. Content from advertisers and other unwanted third parties is not stored, whereby the system is not subject to SPAM. The invention addresses current societal trend and can prevent people from losing “touch” with one another, such as friends and family.

The present invention may also be utilized in commercial environments, such as for collecting video feeds from remote reporters, documenting events, situations, or conditions from field personnel, and so forth. It is also contemplated that at the discretion of the user, this present system can form the basis of an opt-in or push form of advertising wherein users set specific criteria that an advertisement must fulfill prior to being selected, for example: (1) responding to a query and containing a matching code, (2) responsive to one or more items on a “shopping list” or similar structure, (3) forwarded by selected individuals, (4) inclusive of a sufficient level of incentives (i.e. electronic cash), along with alternatives and combinations thereof.

In general, the system provides a mechanism for content distribution that takes advantage of the fact that the television is often the centerpiece of the home environment, which increasingly is supported by wideband connections for both uploading and downloading of content. (Although the system may be utilized with connections having insufficient bandwidth to support real-time content transfers of video and/or audio, it may also be utilized on slower connection for non-real-time content transfers.) Typically, the communication link between the sender and receiver is established when the sender desires to push content to a given receiver, or group of receivers.

The communication link (medium) may comprise any convenient form of remote data transfer infrastructure, such as selected from the group consisting of telephone networks, the Internet, cable television networks, powerline networks, wireless connectivity, and directly wired links. By way of example, the communication link between systems may be established utilizing existing infrastructure within POTS telephones (plain old telephone system), xDSL telephone services, ISDN telephone services, cable television links, Internet links, wireless links, wired links (i.e. WAN or LAN), and other mechanisms and combinations thereof upon which an upload/download connection may be established.

An intermediary server may be employed for transfer and storage, but the connection may also be made directly without utilizing a separate server. For example, the contents may be stored until requested by the user, wherein the need for content storage can be fully or partially shifted from user equipment to that of service providers.

The content may be communicated in any desired format, such as MPEG-4, which provides a preferred scalable communication standard. Additionally, the availability of inexpensive storage media, such as hard disk drives, and removable storage devices facilitate implementation of this content communication system. The system may generally be considered a form of video (and/or audio) mail controlled through a content listing, such as an electronic program guide (EPG). The system preferably utilizes this channel paradigm for the content transfers allowing users to interact with the system in an intuitive manner where content is selected by channel.

The system may operate to provide either a peer-to-peer connection between users (groups, and so forth), or in a client/server mode in which content may be accessed over a wider portion of the network or all of the network. The content distributed by the system is “source pushed” with the user at the receiving end selecting what, when, and if to play the received content.

A transmitter may be incorporated within any content receiving device to allow communicating content back toward an originator, or to other peers. The transmitter is preferably configured with means of encoding source address information about said first peer location, or other form of authentication information. The transmitter is generally configured for attachment to input elements selected from the group of input devices consisting of: video cameras, digital still cameras, video recorders, video cassette recorders, video playback systems, digital video disk systems, audio recording systems, audio playback systems, and so forth and combinations thereof.

The system may be generally considered an apparatus for accessing content shared by peers over a communication medium, comprising: (1) content storage, (2) a communications interface, such as a receiver or transceiver, (3) a playback interface (i.e. video and/or audio), and (4) means for automatically authenticating which content is to be stored in response to a determination as to whether the content has arrived from a user selected peer. A control processor preferably orchestrates the operations of the other elements, including the means for automatic selection of content based on user configuration.

The functions may be integrated within existing systems (i.e. set-top boxes, PCs, and so forth) or may be implemented within a separate component. Aspects of the present invention may be embodied as programming that is executable on systems that provide content communication over a communication medium, content storage, and user program selection means. Distribution of programming according to the invention may be through the distribution of media, including disks, content downloads, and so forth.

The device is connected through a back-channel to the communication medium, which may be selected from the group of remote data transfer infrastructures consisting of telephone networks, the Internet, cable television networks, powerline networks, wireless networks, and directly wired links. It should be appreciated that the device may be configured with one or more of these interfaces so that users may select the desired interface, for instance based on availability or cast factors.

Content that does not match user selected criteria, such as being found within a list of peer addresses or codes, is not stored so that the user is not burdened with unwanted solicitations or other unwanted content. Peer addresses can be directly authenticated based on their originating address, such as caller ID on a telephone line, or IP address when content communicated over the Internet. Peer addresses can be indirectly authenticated based on a username, user code, unit code, password code, identifier from smart card, biometric identifier, other metrics, or combinations thereof that compare favorable with information stored during configuration of the destination system prior to downloading the content. For example a unique ID code associated with a smart card can be transmitted to a remote system as an authentication token that is compared with data stored at the remote location, thereby preventing the storage of unsolicited content.

Preferred embodiments of the invention further comprise means for rendering notification of content which has been stored on the content storage element. By way of example, an electronic program guide is displayed on associated video devices, such as a television. Utilizing an interactive notification within the embodiment allows for rapid and intuitive access (i.e. playback) of the received content in response to interacting with the notification, such as by clicking on it when it is the current cursor context. The program guide generally comprises a listing of channels and associated content, within which a notification of received content is presented. The content notification may include content description, content length value (given as a time length value or a file length value), information about when the content was recorded, and information as to when the content was received.

The apparatus of the invention may be implemented within a separate device, or integrated within a set-top box, television system, audio system, gaming system, personal computer system, or combinations thereof. Content storage may be provided within fixed media (i.e. hard disk drive) or removable media (i.e. R/W DVD), or stored remotely on an intermediary server accessible to the device. It should be appreciated that the present invention may be configured as programming executable on the control processor within conventional set-top boxes or other hardware having the requisite storage and communication interfacing described herein.

The means for automatically selecting content may comprise a computer element and programming configured for execution on the computer element for, (a) establishing communication with a source of video and/or audio content over said communication medium, (b) authenticating the access rights of the content source as a user selected peer, (c) initiating a download of content from the content source, and (d) storing the content received from the content source within the data storage element for user selected playback.

One of the methods of the present invention may be generally described as a method of distributing content over a network, comprising: (1) inputting audio and/or video content using an input device; (2) addressing a recipient destination within a first device; (3) transmitting the audio and/or video content through a back-channel of the first device to the destination over a communication medium; (4) authenticating that the audio and/or video content transmitted by the first device, that is to be received by the second device, has been authorized by a user of the second device; (5) receiving the audio and/or video content over a back-channel of a second device at the destination; and (6) playing the audio and/or video content from the second device. The audio and/or video content is preferably stored within the second device (or in association with it such as in a server) prior to play back of the content.

The method preferably includes generating a notification of the receipt of the audio and/or video content on a program guide displayed by the second device. The invention allows the user to play back content with minimal overhead, and without the need to log onto the Internet and process email attachments.

This system and method may be implemented in a number of alternative ways and a number of aspects of the system and method are described herein.

An aspect of the invention is to provide a method of keeping in touch with friends and family through sharing of audio and video content.

Another aspect of the invention is to provide a virtual channel through which a user can access shared content.

Another aspect of the present invention is to provide an apparatus and method which enables peer-to-peer sharing of events via audio and video content through utilizing the familiar interface of a TV channel.

Another aspect of the present invention is to provide an apparatus and method which enables a user to share content over either broadband or non-broadband connections.

Another aspect of the present invention is to enable peer-to-peer content sharing utilizing existing hard disk recorder technology in a video mail application format.

Another aspect of the invention is providing peer-to-peer sharing of audio and/or video content over a communications medium, such as the telephone, cable, powerline, wireless, or Internet networks.

Another aspect of the invention is to provide access to content sent by a peer without the user being required to log onto the internet, access emails, and play attachments.

Another aspect of the invention is to provide audio and/or video content access from peers for which notification and control is provided through a programming guide.

Another aspect of the invention is to provide authentication that content is from user selected sources prior to storing content at a destination device.

Another aspect of the invention is to provide authentication of content based on the address of the source, such as telephone caller ID, or Internet IP address.

Another aspect of the invention is to provide authentication of content in response to matching of identifiers, passwords, or similar qualifiers, between the content sent to a destination and user selected qualifiers.

Another aspect of the invention is to provide a peer-to-peer content sharing device whose functions can be readily integrated within set-top boxes, television sets, video recording systems, personal computer systems, and other forms of consumer electronics.

Another aspect of the invention is to seamlessly integrate content from peer sources into traditional television programming selection mechanisms.

Further aspects of the invention will be brought out in the following portions of the specification, wherein the detailed description is for the purpose of fully disclosing preferred embodiments of the invention without placing limitations thereon.

### BRIEF DESCRIPTION OF THE SEVERAL VIEWS OF THE DRAWING(S)

The invention will be more fully understood by reference to the following drawings which are for illustrative purposes only:

FIG. 1 is a block diagram of peer-to-peer audio and/or video content sharing according to an embodiment of the present invention implemented within a set-top box.

FIG. 2 is a block diagram of a set-top-box implemented according to an embodiment of the present invention, shown connecting to a back-channel and input and output devices.

FIG. 3 is a block diagram of functionality within a set-top-box implemented according to an embodiment of the present invention.

FIG. 4 is a flow chart of transmitting content from a first set-top box to a second set-top box according to an aspect of the present invention.

FIG. 5 is a flow chart of receiving content at a second set-top box from a first set-top box according to an aspect of the present invention.

FIG. 6 is a screen shot of program guide descriptions of peer content according to an aspect of the present invention, showing the programming guide before and after peer content receipt.

FIG. 7 is a screen shot of program guide descriptions of peer content in a list format according to an aspect of the present invention, showing the programming guide before and after peer content receipt and selection.

FIG. 8 is a screen shot of a content play list of peer content according to an aspect of the present invention.

### DETAILED DESCRIPTION OF THE INVENTION

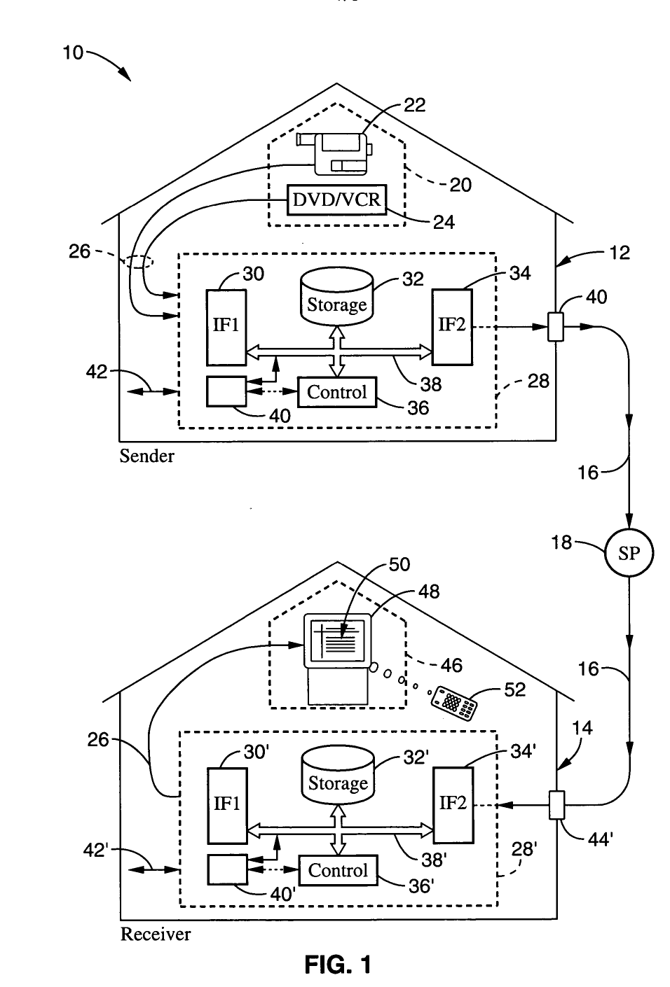

Referring more specifically to the drawings, for illustrative purposes the present invention is embodied in the apparatus, systems and methods generally shown in FIG. 1 through FIG. 8. It will be appreciated that the apparatus and systems may vary as to configuration and as to details of the parts, and that the methods may vary as to the specific steps and sequence, without departing from the basic concepts as disclosed herein.

FIG. 1 shows the communication of audio and/or video 10 between a sender 12 and a receiver 14 over a communication link 16, such as a telephone connection, cable connection, powerline connection, direct network connection, internet connection, or other connection capable of supporting the transfer of video and/or audio data. It should be appreciated that communication link 16 may additionally or alternatively support wireless forms of data transfer, directly from sender to receiver (i.e. between nodes on a single wireless network) or through an intermediary (i.e. wireless to an intermediate node connected by wiring to a node that is connected to a receiver with wired or wireless connections). Communication link 16 may be routed through one or more service providers (SP) 18 for routing the electronic content and providing specialized content related services, such as storage and retrieval of data from the service provider which may also act as a server.

The system allows sharing of content between users over a communication link, such as television cable, telephone linkage, powerline connection, wireless channel, wired link, or other form of electronic communication channel. Examples of content that may be shared between users, such as friends, family, groups, clubs, fellow hobbyists, and so forth include videos, photos, audio, and other forms of electronic content. Preferably the content appears to the receiver as a virtual channel which by way of example and not of limitation, may appear as a television channel (i.e. channel 135) such as within an associated programming guide that lists information about the received content and which preferably can be interacted with for accessing the content.

The communication of content between sender and receiver utilizing the present invention may be executed in real time or non-real time. It is contemplated that the availability of bandwidth between sender and receiver will largely determine whether real time rate transmission is performed, however, it should be appreciated that numerous other factors can come into play. Furthermore, data transfer may take place at rates that exceed real time when high bandwidth connections are available.

Communicating content at a rate equal to or exceeding the real-time communication rate (i.e. signal bandwidth of video being captured) allows the user to begin viewing the content immediately after the connection is established with the sender. In contrast, utilizing a transmission rate that is less than real time, generally requires that the content be viewed after all, or at least a portion of the content has been stored at the destination, for instance within a data storage element such as a hard disk drive or similar mass storage element. Real-time communication may take place over a leased channel, owner channel, cable system, powerline network, high speed telephone connection (i.e. xDSL, ISDN, fiber, etc.), or other communication link having a bandwidth suited to the content to be transmitted.

The content transmitted between sender and receiver is preferably encoded by the sender, such as for security and to compact the data for transmission. By way of example and not of limitation, video content may be encoded according to the MPEG-4 standard. Furthermore, data within the transmitted content, or a header or similar communication handshake preceding the transmission of content, preferably provides secure information that may be utilized by the receiver to determine if the content is to be accepted from the sender. For example source address information, routing path, pass codes, similar forms of additional information or combinations thereof, may be utilized for qualifying content for storage at the receiver.

Sender 12 is configured with one or more electronic content sources 20 and/or input devices, such as a video camera 22, video player 24 (e.g., DVD or VCR player), or other sources of video and/or audio content, which generates electronic content to be communicated to peer 14. Sources 20 are shown connecting by way of an appropriate interface 26 to a content storage subsystem 28 configured for storing and accessing electronic content. Content storage subsystem 28 is preferably implemented within a set-top box unit, however, the general functionality described herein may be implemented within a separate unit or integrated within other devices such as televisions, video recorder systems, personal computer systems, or other systems capable of storing electronic content.

Content storage subsystem 28 comprises a first interface 30 (IF1) to which input and output devices may be connected. This interface is preferably configured for performing short distance communication, such as between components in a local system, or local network. This input/output interface 30 may comprise any desired type of I/O interface over which the audio, video, and/or data content may be received or transmitted, such as IEEE 1394 interface protocol, DVI interface, analog audio-video input, and so forth.

Electronic storage 32 provides a means for storing electronic content, such as by way of a disk drive storage media or removable media, however, it should be appreciated that other forms of electronic data storage may be utilized, such as solid state memories (i.e. Flash memory), and so forth.

A second interface 34 provides a means for interfacing with remote devices, such as over distributed networks, which can be referred to as a back-channel. This long distance back-channel interface 34 is shown connected for convenience through a demarcation connection box 44 (i.e. cable junction box, telephone access point, etc.) providing a physical interface from devices in the home, office, or other physical location, to remote services.

A control unit 36 within the content storage subsystem is configured for transferring electronic content from electronic storage 32 and may be configured for controlling aspects of interfaces 30, 34. The controller preferably includes at least one processing unit (CPU, MPU, DSP) and may be configured for performing a plurality of content storage, control, and/or manipulation functions. The information received and transmitted from content storage subsystem 28 may be processed by control unit 36, stored by a disk drive 32, and transmitted by I/O interfaces at whatever speed is required. By way of example, control unit 36 may perform processing which may include formatting and packetizing of the data associated with the content in a predetermined manner.

A system bus 38 is shown connecting the elements within content storage subsystem 28, although control and data may be alternatively routed between system blocks using separate busses or separate control and data lines. System bus 38 is preferably a parallel bus, however, a serial bus, hybrid serial and parallel bus, optical bus, or any other electronic signal transfer mechanism may be utilized. External access to system bus 38 and/or controller 36 is shown by way of interface 40 to medium 42 which can support additional forms of communication. It will be appreciated that processed content from the system may be supplied to a respective destination by any supported interface, such as either through interface 40 and transmission medium 42 or through back-channel interface 34 connected to communications link 16.

The back-channel may be routed through a modem within interface 34 that is connected to a telephone line (such as a “plain old telephone service” connection (POTS line), a cable modem coupled to a cable TV line, a DSL modem coupled to a DSL connection, an integrated services digital network (ISDN) line, a powerline connection communicating over AC powerline connections, an Ethernet connection to a network of two devices or more, a wireless connection to a network, or other electronic communication channel. It should be appreciated that a number interfaces types may be supported for a given user site, allowing the user to select a desired communication standard based on bandwidth availability and cost factors. Examples of common standards include telephone modem, xDSL modem, cable modem, satellite modem, other wired or wireless connections for creating a channel between two or more devices. The destination may be a service provider, a server, an ISP host, another content storage subsystem 28, and so forth.

At receiver 14, electronic content is received through a second demarcation connection box 44′ into a second content storage subsystem 28′. An output device 46, or devices, such as a high definition television set 48 provide a means for outputting the received content (audio, video, etc.) to the recipient. The system is preferably configured for displaying information about the electronic content received from sender 12 on the display 50 of television set 48, such as within a channel menu, or program guide. A remote control device 52 is shown for controlling playback of the content by the user.

To simplify the ongoing system description, content storage subsystem 28 will herein be generally referred to as a set-top box (STB) which contains the functionality of the present invention along with any other desired functionality or combinations of functionality that may be integrated within a set-top box. It should be appreciated, however, that the present invention may be implemented within other forms of electronic equipment configured for communicating with a remote device.

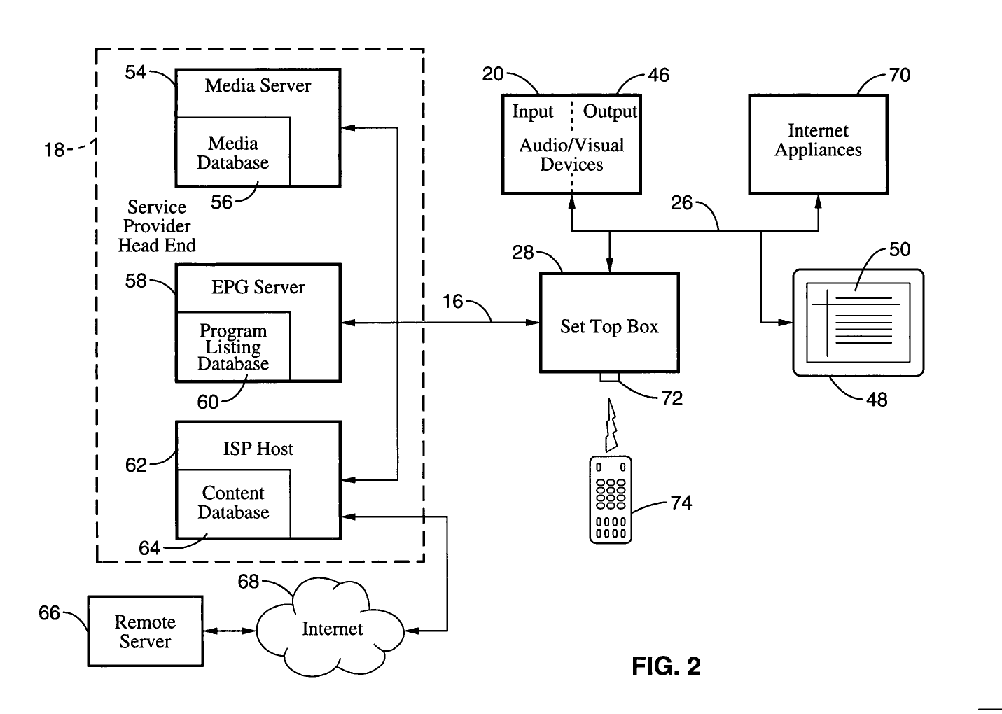

FIG. 2 exemplifies a set-top box 28 connecting to a service provider head-end 18 for an interactive cable or satellite television (TV) system. Service provider head-end 18 is preferably configured with a media server 54 for providing, on demand, movies and other programming obtained from a media database 56. Media server 54 may also be configured for providing additional content such as interviews with actors, games, advertisements, access to available merchandise, associated Web pages, interactive games and other related content. The head-end system also preferably includes an electronic program guide (EPG) server 58 and a program listing database 60 for generating an EPG. STB 28 may also be coupled to an independent service provider (ISP) host 62 by a suitable connection including dial-up connections, DSL (Digital Subscriber Line) or the same transmission medium 16 described above (e.g. using a cable modem) for providing access to services and content from the ISP and internet. The ISP host 62 is configured for providing various content to the user as obtained from a content database 64. STB 28 may also be utilized in conjunction with ISP host 62 operating as an internet portal to provide internet access for obtaining information and content from remote servers, such as exemplified by remote server 66 connected via internet 68. In certain satellite STB application environments, data can be downloaded at very high speed from a satellite link, with asymmetrical upload speed from the set-top box provided via a dial-up or DSL connection.

Set-top box (STB) 28 is preferably configured for providing bi-directional communication over a transmission medium 16. By way of example and not of limitation, bi-directional communication can be implemented using asymmetrical communication techniques, such as utilizing dual communication media with a first media for the uplink and a second media for the downlink. STB 28 may be configured with its own Universal Resource Locator (URL) assigned for providing addressability by the head-end and by internet users.

The media server 54 and EPG server 58 are shown coupled by transmission medium 16 to STB 28. The transmission medium 16 may include, for example, a conventional coaxial cable network, a fiber optic cable network, telephone system, twisted pair, a satellite communication system, a powerline communication system, a radio frequency (RF) system, a microwave or other wireless systems, a combination of wired and wireless systems or any of a variety of known electronic transmission mediums. In the case of a cable television network, transmission medium 16 is commonly realized at the subscriber's premises as a coaxial cable that is connected to a suitable cable connector at the rear panel of STB 28. In the case of a Direct Satellite System (DSS), STB 28 is often referred to as an Integrated Receiver Decoder (IRD). In the case of a DSS system, the transmission medium is a satellite transmission at an appropriate microwave band, and which is typically received by a satellite dish antenna with an integral Low Noise Block (LNB) that serves as a down-converter to convert the signal to a lower frequency for processing by STB 28.

Output 46 from the system is exemplified by a television 48 (tuner and monitor), such as a digital television having a display 50 for displaying programming, an EPG, and the like. STB 28 may be coupled to television 48 and/or various other input 20 and output 46 audio/visual devices. Furthermore, one or more internet appliances 70 may be connected by an appropriate interface 26, which can be any suitable analog or digital interface, typically a local (short haul) interface. In one embodiment, interface 26 conforms to an interface standard such as the Institute of Electrical and Electronics Engineers (IEEE) 1394 standard.

The STB 28 may include a central processing unit (CPU) and memory such as Random Access Memory (RAM), Read Only Memory (ROM), flash memory, mass storage such as a hard disc drive, floppy disc drive, optical disc drive, or may accommodate other electronic storage media, and so forth. Such memory and storage media is suitable for storing data as well as instructions for programmed processes for execution on the CPU, as will be discussed later. Information and programs stored on the electronic storage media or memory may also be transported over any suitable transmission medium 26 as illustrated in the figure.

STB 28 may include circuitry or programming suitable for audio and/or video decoding and processing, for example the decoding of video data compressed in accordance with a compression standard such as the Motion Pictures Experts Group (MPEG) standard. Alternatively, components of STB 28 may be incorporated into television set 48 itself, thereby eliminating the need for a separate STB 28. Furthermore, a computer unit, such as one having an integrated television tuner may be substituted for television 48 and STB 28 without departing from the teachings of the present invention.

By way of example, STB 28 may be coupled to devices such as a personal computer, TV tuner, video cassette recorder, camcorder, digital camera, personal digital assistant and other audio/visual or Internet related devices. In addition, a data transport architecture, such as that set forth by an industry group which includes Sony Corporation® and which is known as the Home Audio-Video Interoperability (HAVi™) architecture may be utilized to enable interoperability among devices on a network regardless of the manufacturer of the device. This enables formation of a home network system wherein electronic devices and Internet appliances are compatible with each other. The STB 28 is preferably configured to run an operating system suitable for a home network system such as the Aperios™ real time operating system by Sony Corporation, although other operating systems may be alternatively utilized.

STB 28 preferably includes an infrared (IR) receiver 72 for receiving IR signals from an input device such as remote control 74. Alternatively, it is noted that many other control communication methods may be utilized besides IR, such as wired or wireless radio frequency, and so forth. In addition, it can be readily appreciated that IR input device 72 may be substituted with any device suitable for controlling STB 28, for instance a remote control, personal digital assistant, laptop computer, keyboard or computer mouse. In addition, an input device in the form of a control panel located on television unit 48 or STB 28 can be provided.

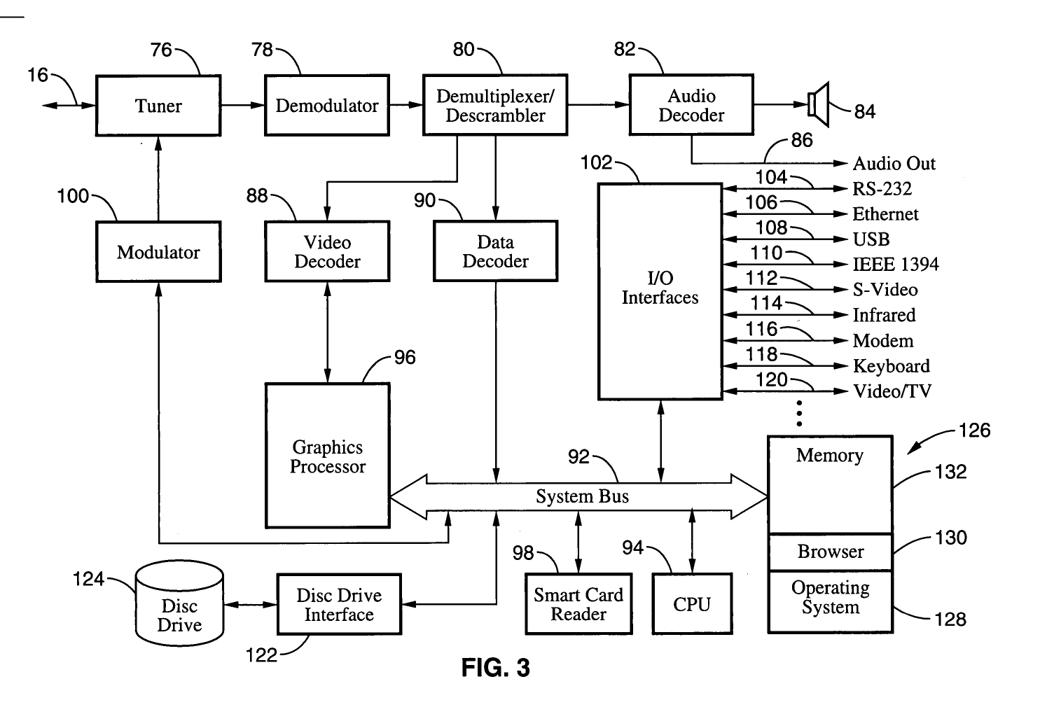

FIG. 3 exemplifies an embodiment of a digital set-top box 28 according to the invention. In this exemplary set-top box, the transmission medium 16, such as a coaxial cable, is coupled by a suitable interface to a tuner 76. By way of example tuner 76 may include a broadcast in-band tuner for receiving content, an out-of-band tuner for receiving data transmissions and a return path tuner for providing an out of band (OOB) return path for outbound data (destined for example for the head-end). A separate tuner (not shown) may be provided to receive conventional RF broadcast television channels. Modulated information received through the tuner may be formatted, such as according to the MPEG-2 standard, and is demodulated at a demodulator 78. The demodulated information at the output of demodulator 78 is provided to a demultiplexer and descrambler circuit 80 where the information is separated into discrete channels of programming. The programming is divided into packets, each packet bearing an identifier called a Packet ID (PID) that identifies the packet as containing a particular type of data (e.g. audio, video, data). The demodulator and descrambler circuit 80 can be optionally configured to decrypt encrypted information in accordance with a decryption algorithm to prevent unauthorized access to programming content.

Audio packets from the demultiplexer 80 (those identified with an audio PID) are decrypted and forwarded to an audio decoder 82 where they may be converted to analog audio to drive a set of speakers (i.e. a stereo or home theater multiple channel audio system) or other audio system 84 (e.g. stereo or home theater multiple channel amplifier and speaker systems) or may simply provide decoded audio output 86. Video packets from demultiplexer 80 (those identified with a video PID) are decrypted and forwarded to a video decoder 88. In a similar manner, data packets from demultiplexer 80 (those identified with a data PID) are decrypted and forwarded to a data decoder 90.

Decoded data packets from data decoder 90 are sent over system bus 92 to central processing unit (CPU) 94, which controls operations within the STB. It should be appreciated that the CPU may be implemented with any convenient form of electronic controller such as programmable elements that may comprise at least one CPU, MPU, or the like. CPU 94 can thus access the decoded data from data decoder 90 via system bus 92. Video data decoded by video decoder 88 is passed to a graphics processor 96, which is a processing element optimized for rapidly manipulating graphics data. Graphics processor 96 is particularly useful in processing graphics intensive data associated with Internet browsing, gaming and multimedia applications such as those associated with MHEG (Multimedia and Hypermedia information coding Experts Group) set-top box applications. It should be noted, however, that the function of graphics processor 96 may be unnecessary in some set-top box designs having lower capabilities, wherein the functionality of graphics processor 96 may be executed by CPU 94, such as in applications where the decoded video is passed directly from the demultiplexer 80 to a video encoder. Graphics processor 96 is coupled to system bus 92 and operates under the control of CPU 94.

STB 28 may incorporate a smart card reader 98 for communicating with a so called “smart card”, often serving as a Conditional Access Module (CAM). The CAM typically includes its own separate control processor (CPU) along with associated memory (i.e. RAM and ROM). Smart card reader 98 may be utilized for coupling system bus 92 of STB 28 to the smart card serving as a CAM (not shown). Smart card based CAMs are typically utilized for authenticating users and transactions carried out by the user, and/or the authorization of services and the storage of authorized cryptography keys. For example, the CAM can be used to provide the key for decoding incoming cryptographic data for content that the CAM determines the user is authorized to receive.

STB 28 can operate in a bi-directional communication mode so that data and other information can be transmitted not only from the head-end of the system to the end user, or from a service provider to the end user of STB 28, but also, from the end user upstream using an out-of-band channel. In one embodiment, such data passes through system bus 92 to a modulator 100 through the tuner (operating as a return path OOB tuner) and out through the transmission medium 16. This capability may be utilized to provide a mechanism for STB 28 and/or its user to send information to the head-end (e.g. service requests or changes, registration information, etc.) as well as to provide fast outbound communication with the Internet or other services provided at the head-end to the end user.

STB 28 may include any of a plurality of I/O (Input/Output) interfaces represented by I/O interfaces 102 that permit interconnection of I/O devices to STB 28. By way of example, and not limitation, a serial RS-232 port 104 can be provided to enable interconnection to any suitable serial device supported by the internal software of STB 28. Similarly, communication with compatible devices can be provided via an Ethernet port 106, a USB (Universal Serial Bus) port 108, an IEEE 1394 (so-called firewire or i-link) or IEEE 1394 wide port 110, S-video port 112 or infrared port 114. Such interfaces can be utilized to interconnect STB 28 with any of a variety of accessory devices such as storage devices, audio and/or visual devices 120, gaming devices (not shown), Internet Appliances, along with any other desired electronic devices and/or equipment.

Additionally, peripherals may be connected to I/O interface 102 of STB 28, common peripherals by way of illustration comprising a modem (i.e. dial-up, cable, DSL or other technology modem) connected through modem port 116 to facilitate high speed or alternative access to the Internet or other data communication functions. In one preferred embodiment, modem port 116 is that of a DOCSIS (Data Over Cable System Interface Specification) cable modem to facilitate high speed network access over a cable system, and port 116 is appropriately coupled to the transmission medium 16 embodied as a coaxial cable. Consequently, STB 28 can perform bi-directional communication via the DOCSIS cable modem with STB 28 being identified by a unique URL (Universal Resource Locator).

A PS/2 or other keyboard/mouse/joystick interface 118 can be provided to simplify data entry to STB 28. User interface inputs support devices for capturing user data and control entry, such as menu navigation utilizing pointing devices. It should be appreciated that set-top boxes, televisions, gaming consoles, video record and playback system, and similar interactive systems already provide a user interface for user control.

STB 28 may also incorporate one or more video outputs 120 that can provide direct connection to a television set, or similar video display (or recording) device. In one embodiment, video output 120 is configured to provide composite video formatted as NTSC (National Television System Committee) video. An embodiment may be configured with video output 120 implemented to provide a direct connection to graphics processor 96 or the demultiplexer/descrambler 80 instead of through system bus 92 as illustrated in the exemplary block diagram. S-Video signals from output 112 can be similarly provided without passing through system bus 92 if desired in other embodiments.

Infrared port 114 can be embodied as an infrared receiver 72 as illustrated in FIG. 2, to receive commands from an infrared remote control 74, infrared keyboard or other infrared control device. Although not explicitly shown, front panel controls may be provided in within embodiments of the invention to directly control the operation of STB 28 through a front panel control interface, such as controlled through interface 102. It will be appreciated that interface 102 can be configured to support any desired electronic interface, without departing from the teachings of the present invention. Furthermore, the interfaces supported by interface 102, or other portions of STB 28, may be utilized separately or in combinations thereof.

STB 28 may include a disc drive interface 122 and disc drive mass storage 124 for user storage of content and data as well as providing storage of programs operating on CPU 94. STB 28 may additionally, or alternatively, include floppy disc drives, CD ROM drives, CD RNV drives, DVD drives, solid-state “drives”, holographic drives, and other means of electronic data storage (not shown). To perform computer operations, CPU 94 is coupled through system bus 92 to memory 126. Memory 126 is shown comprising memory 128 for retaining an operating system, memory 130 for retaining a browser 132, along with stack, buffering, and other uncommitted memory 134. Memory 126 may comprise any suitable memory technology including Random Access Memory (RAM), Read Only Memory (ROM), Flash memory, Electrically Erasable Programmable Read Only Memory (EEPROM), other forms of electronic storage elements, and combinations thereof.

While the above exemplary system including STB 28 is illustrative of the basic components of a digital set-top box suitable for use with the present invention, the architecture shown should not be considered limiting since many variations of the hardware configuration are possible without departing from the present invention. Furthermore, the invention may be embodied in programming operable on a system having the necessary hardware functionality, such as within a set-top box unit.

Considering the operation of STB 28, an appropriate operating system such as Sony Corporation's Aperios™ real time operating system is generally loaded into, or is permanently stored within, active memory 128 along with the appropriate drivers for communication with the various interfaces. Along with the operating system and associated drivers, STB 28 would preferably be operated with software for a browser retained in active memory 130 which may permanently reside in non-volatile storage, such as ROM or EEPROM. The browser software typically operates as the mechanism for viewing not only web pages on the internet, but also serves as the mechanism for viewing an Electronic Program Guide (EPG) formatted as an HTML document. The browser stored in memory 130 may be optionally configured according to the invention for providing mechanisms for viewing normal programming (wherein normal programming is viewed as an HTML video window—often occupying the entire area of a television screen).

Although set-top box software architectures can vary depending upon the operating system, these systems generally incorporate hardware interface layers in their lowest system layer. Above the hardware interface layer is traditionally an operating system layer as previously described. The software architectures of modern STBs have generally evolved to include a next layer referred to as “middleware”, permitting STB applications to execute across multiple platforms substantially without regard for which operating system is in place. Currently, middleware standards have been evolving around JavaScript and HTML (HyperText Markup Language) virtual machines. At the top layer of the system software is the application layer where user applications and the like reside (e.g. browsing, email, EPG, Video On Demand (VOD), rich multimedia applications, pay per view, etc.). The current invention can be utilized with any suitable set-top box software architecture.

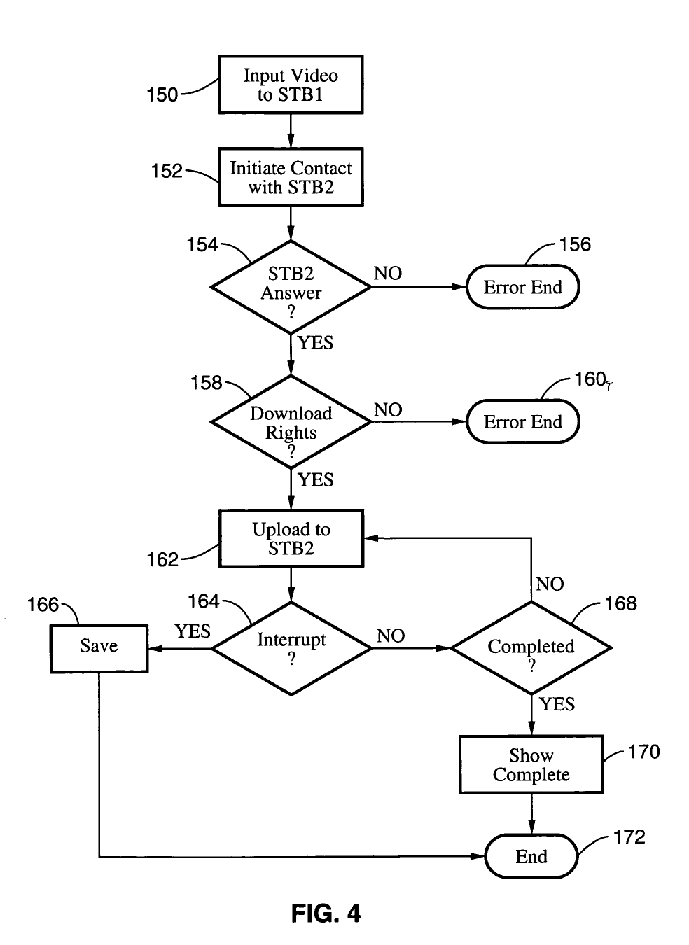

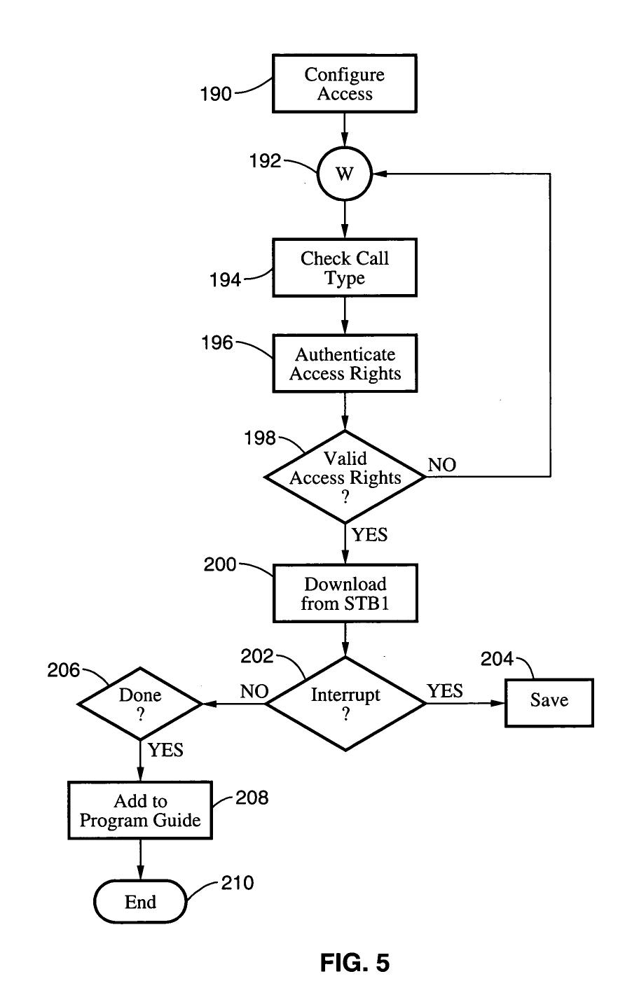

FIG. 4 and FIG. 5 exemplify communication between a first STB, referred to as STB1, as utilized by a first user, referred to as User1, and a second remote STB, STB2 utilized by User2, when transferring content (audio, video, and/or data) from STB1 to STB2.

The user at STB2 can optionally configure their system for selective content receipt by setting access rights as exemplified by block 190 of FIG. 5 establishing who is allowed to download content (video, audio, etc.) to STB2. This authentication step can provide a mechanism allowing users to avoid the nuisance of unsolicited content by advertisers, marketers, survery-takers, or prank downloads. To configure access rights within STB2, the user preferably enters identifying information for the content sources, or other forms by which the incoming streams may be filtered. For example, if receiving content over a modem, the telephone number may be entered for the content source. If content is to be received over the internet then identifying information, such as IP addressing may be utilized. It should be appreciated that access rights may be based on source address information or on values included within the communication that match up with parameters set by the user to identify valid content.

Content to be shared is input by User1 as shown in block 150 of FIG. 4. Input may be generated from any input device, such as a video camera, television tuner, video recorder, or other content source. The visual and/or audio content is stored by STB1, along with optional information such as titles.

During this time STB2 is retained in a standby mode awaiting receipt of content as per block 192 of FIG. 5.

After User1 defines, or otherwise selects, the destination for the content then STB1 initiates contact with STB2 as depicted in block 152 of FIG. 4. The steps may be combined, such as in the case of manually dialing the phone number, or manually entering the IP address. It should be appreciated that the destination may be defined through selecting one or more entries in an address book or list, or similar mechanisms for user selection of a destination.

As the communication is received by STB2, STB2 checks the call type as represented by block 194 of FIG. 5. If the call is from another STB (or other allowable content source), then STB2 proceeds toward authenticating the access rights of the sender or content, the sender in this case being STB1. Authentication can take a number of forms, such as through the use of a configuration list.

STB1 waits while checking for an answer from STB2, such as according to predefined time limits, as depicted in block 154. If no answer from STB2 is detected within the time limits, then STB1 generates an error message and ends as shown in block 156 of FIG. 4. If STB2 answers, then STB1 moves to a new state and awaits authentication of access rights by STB2.

Access rights are authorized by STB2 as shown in block 196 of FIG. 5. Authentication may take a number of alternative forms, for example authentication of a transmitting STB with valid access privileges may be performed based on IP address confirmation, Caller ID for telephone number confirmation, and other mechanisms for limiting access to STB2 by remote STBs or other content sources that may be attempting to utilize this pathway to pass content to the STB.

If access rights are checked as per block 198 of FIG. 5, and found to be invalid (not authentic), then STB2 returns to block 192 of FIG. 5, to await communication associated with authenticated content. Alternatively User2 may be prompted by the system to ask whether the user would like to accept the incoming access attempt by STB1. If User2 allows the access attempt, or if the access attempt is actually valid, then STB2 enters a state to download the stored information as represented in block 200.

If STB1 detects at block 158 of FIG. 5 that access rights for the transmission have been denied by STB2, then an error is generated and the transmission is aborted as shown in block 160. If the access rights are authorized, or User2 otherwise agrees to the access request, then uploading commences from STB1 to STB2 as per block 162 of FIG. 4. It is preferred that information such as title, duration (or file size) be communicated before the body of the content, such as within a header, wherein this information is made available to STB2, and optionally the user, before or at the beginning of the content transfer. It should be appreciated that the data transfer rate may be at real-time speed or it may be faster or slower than the real-time speed, depending on the equipment utilized at each end, the bandwidth of the communication channel, and the user settings for STB1 and STB2.

STB1 is subject to interruption of the transfer as shown by block 164, for example disruption of the communication channel by an incoming phone call, physical disconnection, and so forth. If an interrupt occurs STB1 moves to a new state represented by block 166 saving the information (including download status and progress information so that the download need not restart from the beginning upon subsequent reconnection) and then moves to and end state as per block 172. If an interrupt was not detected in block 164 of FIG. 4, then STB1 proceeds to check as depicted by block 168 if the upload was complete. If the upload was incomplete then execution returns to block 162 and uploading continues, otherwise STB1 advances to indicate completion of the upload, such as by displaying a message that the content transfer is “COMPLETED”, as per block 170 and terminates the upload process as per block 172.

STB2 checks for an interruption as per block 202 of FIG. 5, and saves the information as per block 204 and terminates at block 210 if the transfer was interrupted. If no interrupt occurred then STB2 checks if the download was completed as per block 206. If the download was not complete, then execution returns to block 200 to complete the download. If the download is complete, STB2 preferably adds the received content to the program guide (or other adopted notification mechanism) as shown in block 208 and ends the downloading as depicted in block 210.

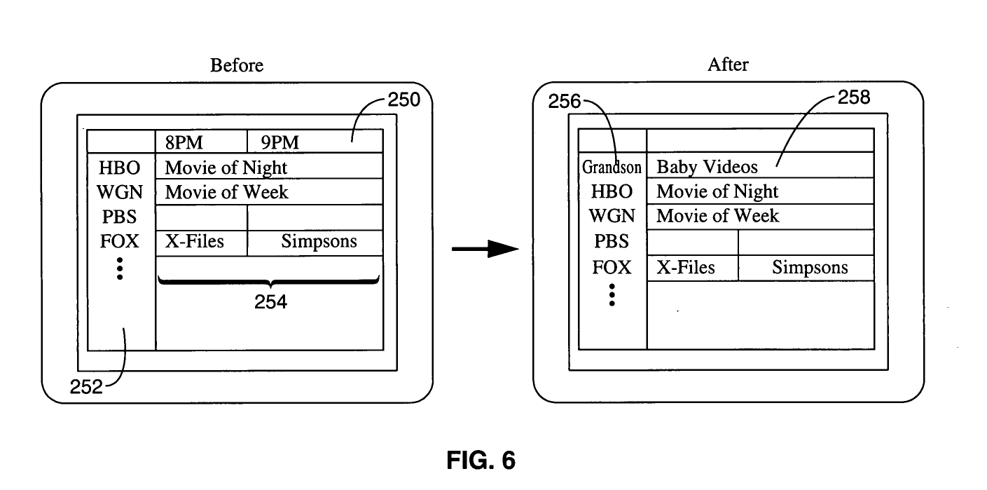

FIG. 6 through FIG. 8 illustrate examples of mechanisms that the system may utilize for providing notification and information about received content. One preferred notification mechanism is performed by adding channels as necessary to a program guide in response to received content.

FIG. 6 illustrates an example of an electronic program guide (EPG) with and without a virtual channel. A conventional format is shown on the left with a header 250 that typically displays date and time information. The body of the programming guide contains fields for listing of channels 252, as well contents 254 available for that channel, such as at specific programmed times or for randomly accessible content. The programming guide depicted on the right of the figure reflects the addition of a virtual channel 256 inserted in response to received content, displaying information about the received content. In the present example, the content is labeled “Grandson” and has one or more content entries 258, herein labeled “Baby videos”. The user can then access the received content by scrolling through the list of channels and selecting the virtual channel. Alternatively, the user can enter a number or code on a local or remote keypad to select the virtual channel directly. When the virtual channel is selected, the system accesses the content associated with the virtual channel from a hard disk drive or other storage media (e.g., by shunting to the storage media instead of accessing content over a broadcast or cable channel). Examples of electronic program guides with virtual channels can be found in published U.S. Patent Application No. 2002/0157100 and published U.S. Patent Application No. 2002/0157098, both of which are incorporated herein by reference in their entirety.

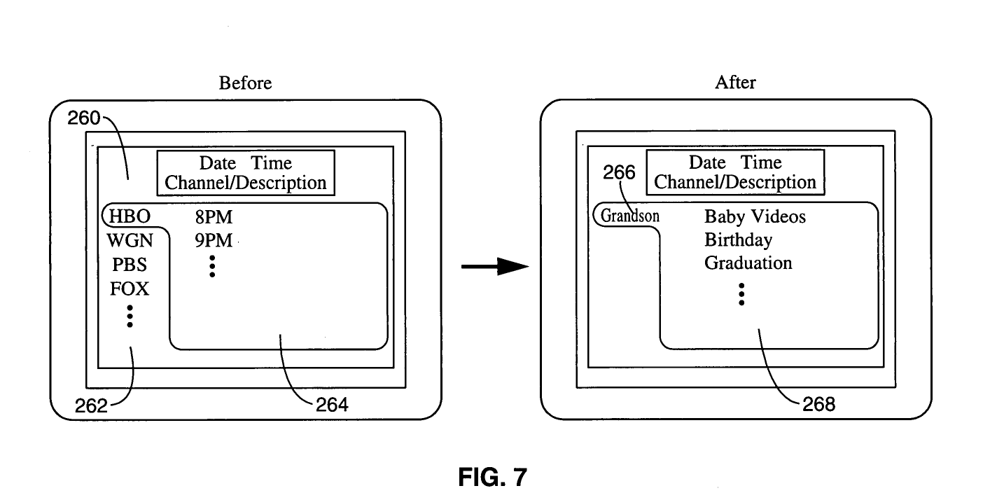

FIG. 7 illustrates a listing form of program guide wherein the contents for a particular channel are listed when scrolling through the list of channels. A header section 260 is illustrated under which are listed channels 262, one of which (i.e. HBO®) is selected, wherein a drop down sequential list 264 of times and content for the channel are depicted. The program guide to the right of the figure is displayed after the system receives content from a remote user, group, or other authorized entity. A new virtual channel 266 is displayed in association with the content, herein listed as “Grandson”, which has been selected to drop down a selection list 268 that is displayed with content elements available on that virtual channel, such as “Baby Videos, Birthday, Graduation”, and any other content received. It should be appreciated that content from each different source may be displayed on a separate virtual channel, or that multiple content sources may be displayed on a single, or a limited number of virtual channels.

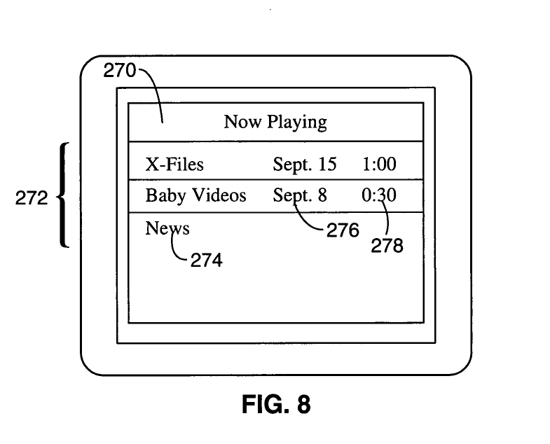

FIG. 8 depicts an alternate to the channel listing program guide format. It should also be recognized that the present invention may be implemented with any convenient form of content notification. For example, since the present system may be integrated with devices traditionally associated with a single channel, such as a video recorder, the available content may be listed without a long list of channels. FIG. 8 accordingly depicts a header section 270 (i.e. with system status and other general information) displayed over a content list 272, which lists by way of example content description 274, date recorded 276 (and/or date received), and content length 278 (i.e. hours and minutes and/or file size).

It will be appreciated that the system can be configured in various ways for the convenience of the user. For example, the system may be configured to display content upon selecting the associated channel, or even immediately upon receipt of that content. It should also be appreciated that the present system may be configured for displaying and controlling content selection in a number of alternative ways, such as depending on the application to which the system is applied.

Although the description above contains many details, these should not be construed as limiting the scope of the invention but as merely providing illustrations of some of the presently preferred embodiments of this invention. Therefore, it will be appreciated that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

1. An apparatus for sharing media content among peers over a communication medium, comprising:
a receiver configured to automatically receive media content from at least one preauthorized sender over a communication medium;
a data storage element associated with said receiver and configured to store said received media content; and
a user interface associated with said receiver and configured to provide access to said received media content by selection of a virtual channel by a user;
wherein selection of said virtual channel results in retrieval of said received media content from said data storage element for playback.

2. An apparatus as recited in claim 1, further comprising:
means for automatically authenticating media content arriving at said receiver for storage within said data storage element in response to a determination as to whether said content is from a preauthorized sender.

3. An apparatus as recited in claim 2, wherein said determination of a preauthorized sender is performed in response to a source address of said received media content.

4. An apparatus as recited in claim 3, wherein said source address comprises an address transmitted over said communication medium.

5. An apparatus as recited in claim 4, wherein said address comprises a phone number or internet protocol (IP) address.

6. An apparatus as recited in claim 2, wherein said determination of a preauthorized sender is performed in response to an identifier known by said means for automatically authenticating which of said media content arriving at said receiver is to be stored within said data storage element in response to a determination as to whether said content is from a preauthorized sender.

7. An apparatus as recited in claim 6, wherein said identifier is selected from the group consisting essentially of a username, user code, unit code, password code, identifier from a smart card, biometric identifier, and combinations thereof.

8. An apparatus as recited in claim 1, further comprising means for providing notification of media content having been stored on said content storage element.

9. An apparatus as recited in claim 8, wherein said media content may be accessed by interacting with said notification.

10. An apparatus as recited in claim 9, wherein said media content is played back in response to user interaction with said notification.

11. An apparatus as recited in claim 8, wherein said notification is presented to said user within a program guide.

12. An apparatus as recited in claim 11, wherein said program guide comprises a listing of channels and associated content, within which a notification of said received media content is presented.

13. An apparatus as recited in claim 8, wherein said notification further comprises a content length value given as a time length value or a file length value.

14. An apparatus as recited in claim 12, wherein said notification further comprises information about when the media content was recorded.

15. An apparatus as recited in claim 12, wherein said notification further comprises information about when the media content was received at said receiver.

16. An apparatus as recited in claim 1, wherein said apparatus is integrated within a device selected from the group consisting essentially of a set-top box, television system, audio system, gaming system, personal computer system, and combinations thereof.

17. An apparatus as recited in claim 1, further comprising:
a transmitter configured for connection to an input element for transmitting said media content from a first peer location to a second peer location over said communication medium; and
means for encoding source address information about said first peer location for transmission with said media content to said second peer location.

18. An apparatus as recited in claim 17, wherein said transmitter is configured for attachment to input elements selected from the group of consisting essentially of a video camera, digital still camera, video recorder, video cassette recorder, video playback system, digital video disk system, audio recording system, audio playback system, and combinations thereof.

19. An apparatus as recited in claim 1, wherein said receiver is connected through said communication medium through a back-channel.

20. An apparatus as recited in claim 1, wherein said communication medium is selected from the group consisting essentially of a telephone network, the Internet, a cable television network, a powerline network, a wireless network, and a directly wired link.

21. An apparatus as recited in claim 1, wherein said data storage element is located on an intermediary server.

22. An apparatus as recited in claim 1, wherein said data storage element comprises a fixed or removable data storage media.

23. An apparatus as recited in claim 1, wherein said data storage element comprises a hard disk drive.

24. An apparatus as recited in claim 1, wherein said means for automatically authenticating media content arriving at said receiver for storage within said data storage element in response to a determination as to whether said media content is from a preauthorized sender comprises:
a computer; and
programming executable by said computer for carrying out the operations of
establishing communication with a source of media content over said communication medium,
authenticating the access rights of said source as a user selected peer,
initiating a download of said media content from said source, and
storing said media content received from said source within said data storage element for user selected playback.

25. An apparatus for sharing media content among peers over a communication medium, comprising:
a computer;
a data storage element associated with said computer;
programming executable by said computer for carrying out the operations of
establishing a communication link with a source of media content over said communication medium,
automatically authenticating access rights of said source of media content as a user selected peer,
automatically receiving media content from an authenticated source of media content,
automatically storing said media content received from said authenticated source within said data storage element for user selected playback, and
providing a user interface associated with said computer and configured to provide access to said received media content by selection of a virtual channel by a user;
wherein selection of said virtual channel results in retrieval of said received media content from said data storage element for playback.

26. An apparatus as recited in claim 25, wherein authentication of access rights is performed in response to a source address of said media content.

27. An apparatus as recited in claim 26, wherein said source address comprises an address transmitted over said communication medium.

28. An apparatus as recited in claim 27, wherein said address comprises a phone number or internet protocol (IP) address.

29. An apparatus as recited in claim 1, wherein said authentication of access rights is performed in response to a source identifier.

30. An apparatus as recited in claim 29, wherein said source identifier is selected from the group consisting essentially of a username, user code, unit code, password code, identifier from a smart card, biometric identifier, and combinations thereof.

31. An apparatus as recited in claim 25, further comprising means for providing notification of media content having been stored on said content storage element.

32. An apparatus as recited in claim 31, wherein said media content may be accessed by interacting with said notification.

33. An apparatus as recited in claim 32, wherein said media content is played back in response to user interaction with said notification.

34. An apparatus as recited in claim 31, wherein said notification is presented to said user within a program guide.

35. An apparatus as recited in claim 34, wherein said program guide comprises a listing of channels and associated content, within which a notification of said received media content is presented.

36. An apparatus as recited in claim 31, wherein said notification further comprises a content length value given as a time length value or a file length value.

37. An apparatus as recited in claim 35, wherein said notification further comprises information about when the media content was recorded.

38. An apparatus as recited in claim 35, wherein said notification further comprises information about when the media content was received at said receiver.

39. An apparatus as recited in claim 25, wherein said apparatus is integrated within a device selected from the group consisting essentially of a set-top box, television system, audio system, gaming system, personal computer system, and combinations thereof.

40. An apparatus as recited in claim 25, further comprising:
a transmitter configured for connection to an input element for transmitting said media content from a first peer location to a second peer location over said communication medium; and
means for encoding source address information about said first peer location for transmission with said media content to said second peer location.

41. An apparatus as recited in claim 40, wherein said transmitter is configured for attachment to input elements selected from the group of consisting essentially of a video camera, digital still camera, video recorder, video cassette recorder, video playback system, digital video disk system, audio recording system, audio playback system, and combinations thereof.

42. An apparatus as recited in claim 25, wherein said computer includes a communication interface connected through said communication medium through a back-channel.

43. An apparatus as recited in claim 25, wherein said communication medium is selected from the group consisting essentially of a telephone network, the Internet, a cable television network, a powerline network, a wireless network, and a directly wired link.

44. An apparatus as recited in claim 25, wherein said data storage element is located on an intermediary server.

45. An apparatus as recited in claim 25, wherein said data storage element comprises a fixed or removable data storage media.

46. An apparatus as recited in claim 25, wherein said data storage element comprises a hard disk drive.

47. A computer program carried by computer readable storage media and executable by a computer, said computer program configured to cause said computer to carry out the steps comprising:
establishing a communication link with a source of media content over a communication medium,
automatically authenticating access rights of a source of media content as a user selected peer,
automatically receiving media content from an authenticated source of media content,
automatically storing said media content received from said authenticated source within said data storage element for user selected playback, and
providing a user interface associated with said computer and configured to provide access to said received media content by selection of a virtual channel by a user;
wherein selection of said virtual channel results in retrieval of said received media content from said data storage element for playback.

48. An computer program as recited in claim 47, wherein authentication of access rights is performed in response to a source address of said media content.

49. A computer program as recited in claim 48, wherein said source address comprises an address transmitted over said communication medium.

50. A computer program as recited in claim 49, wherein said address comprises a phone number or internet protocol (IP) address.

51. A computer program as recited in claim 47, wherein said authentication of access rights is performed in response to a source identifier.

52. A computer program as recited in claim 51, wherein said source identifier is selected from the group consisting essentially of a username, user code, unit code, password code, identifier from a smart card, biometric identifier, and combinations thereof.

53. A method for sharing media content among peers over a communication medium, comprising:
establishing a communication link with a source of media content over a communication medium;
automatically authenticating access rights of a source of media content as a user selected peer;
automatically receiving media content from an authenticated source of media content;
automatically storing said media content received from said authenticated source within said data storage element for user selected playback; and
providing a user interface associated with said computer and configured to provide access to said received media content by selection of a virtual channel by a user;
wherein selection of said virtual channel results in retrieval of said received media content from said data storage element for playback.

54. A method as recited in claim 53, wherein authentication of access rights is performed in response to a source address of said media content.

55. A method as recited in claim 54, wherein said source address comprises an address transmitted over said communication medium.

56. A computer program as recited in claim 55, wherein said address comprises a phone number or internet protocol (IP) address.

57. A computer program as recited in claim 53, wherein said authentication of access rights is performed in response to a source identifier.

58. A computer program as recited in claim 57, wherein said source identifier is selected from the group consisting essentially of a username, user code, unit code, password code, identifier from a smart card, biometric identifier, and combinations thereof.
